(19) United States
(12) Patent Application Publication
(10) Pub. No.: US 2007/0255868 A1
(43) Pub. Date: Nov. 1, 2007

(54) Method and system for managing a network device using a slave USB interface

(75) Inventors: Gurinderjit Chahal, Fremont, CA (US); Shashi Kumar, San Jose, CA (US)

Correspondence Address: LAW OFFICE OF CHARLES E. KRUEGER, P.O. BOX 5607, WALNUT CREEK, CA, 94596-1607, US

(73) Assignee: CISCO TECHNOLOGY, INC. (A California Corporation)

(21) Appl. No.: 11/411,609

(22) Filed: Apr. 26, 2006

(51) Int. Cl. G06F 13/38

(52) U.S. Cl. 710/62

(57) ABSTRACT

A network device includes a USB slave port for connection to a computer to allow configuration and management of the network device utilizing the plug and play capability of interfaces defined by the USB standard.

### BACKGROUND OF THE INVENTION

Network devices, such as switches, routers, bridges, etc., include a console port that provides a connection to a terminal for communicating with the network device. Most network devices also provide network access methods such Telnet, HTTP, and SNMP. However, the console port is required for cases when the access to the network device via a network is not possible.

The console port is a serial port that allows the terminal to be connected to and to communicate with the network device over a serial cable. A stand alone CRT, PC, or workstation can be used as a console and the console must run a character-based user interface. If a PC (Personal Computer) is used as a console it must run terminal emulator software that is included with most operating systems. Some network devices enable configuration through a browser application running on a connected PC.

Use of these console interfaces requires the user to perform steps as documented for the interface, such as launching a browser and entering a specific IP, pushing buttons, etc. Also, many PCs, especially laptops, no longer include a connector for a serial interface but only include a USB interface.

New techniques have been developed using the USB (Universal Serial Bus) interface to communicate with a network device. In one technique a network device has a master USB port for reading an image or configuration file from a mass storage device coupled to the master USB port. In another technique, the network device includes a slave USB port and the terminal has special applications developed to perform management functions normally performed over a serial port.

Thus, existing techniques do not allow a user to utilize the plug and play features to the USB port for setting up and configuring a network device without having special software installed on the user's computer.

### BRIEF DESCRIPTION OF THE DRAWINGS

FIG. 1 is a block diagram of an embodiment of the invention in the form of a network device having a USB slave port;

FIG. 2 is a block diagram of an embodiment of the invention in the form of a network device having a USB slave port/serial protocol conversion module; and

FIG. 3 is a block diagram of an embodiment of the invention in the form of a network device having a USB slave port/Ethernet protocol conversion module.

### DETAILED DESCRIPTION OF THE INVENTION

Reference will now be made in detail to various embodiments of the invention. Examples of these embodiments are illustrated in the accompanying drawings. While the invention will be described in conjunction with these embodiments, it will be understood that it is not intended to limit the invention to any embodiment. On the contrary, it is intended to cover alternatives, modifications, and equivalents as may be included within the spirit and scope of the invention as defined by the appended claims. In the following description, numerous specific details are set forth in order to provide a thorough understanding of the various embodiments. However, the present invention may be practiced without some or all of these specific details. In other instances, well known process operations have not been described in detail in order not to unnecessarily obscure the present invention.

In the following, various embodiments of a technique to utilize the plug and play USB features included in commercially available PC operating systems to communicate with and manage a network device utilizing the USB interface will be described.

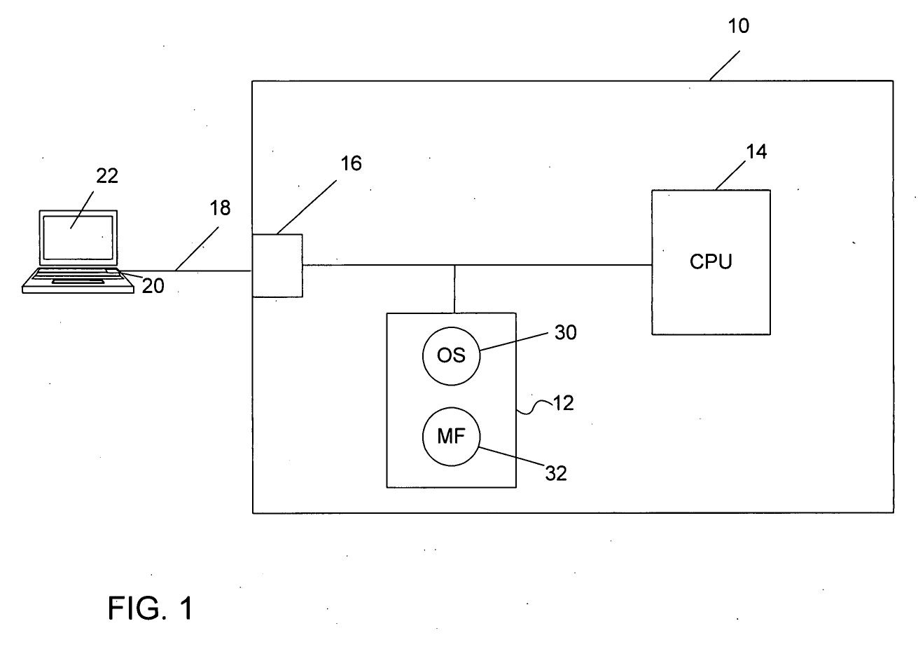

A first embodiment of the invention is depicted in FIG. 1. The network device 10 includes a memory 12, for example flash memory, a processor 14, and a slave USB port 16 that is coupled via a cable 18 to a master USB port 20 on the PC 22. The operating system of the PC 22 automatically treats the network device connected to its USB master port as a mass storage device. The memory stores an image of the operating system 30 and a management file 32.

In this embodiment, when the PC is connected to the network device through the USB interface, the network device presents itself as a generic mass storage device (such as compact flash) and the generic mass storage device appears as a drive on the PC that stores a management file in the form of a text configuration file. The user updates the text file using standard text editors and saves the file. When the file is saved, the network device executes program code which translates the settings of the file into the desired configuration.

It is also possible to represent the management file as a configuration file in Word or Excel file formats instead of text. Similarly, the user can upgrade the switch image by copying the image from a PC folder into the network device folder (presented by the network device as a storage device).

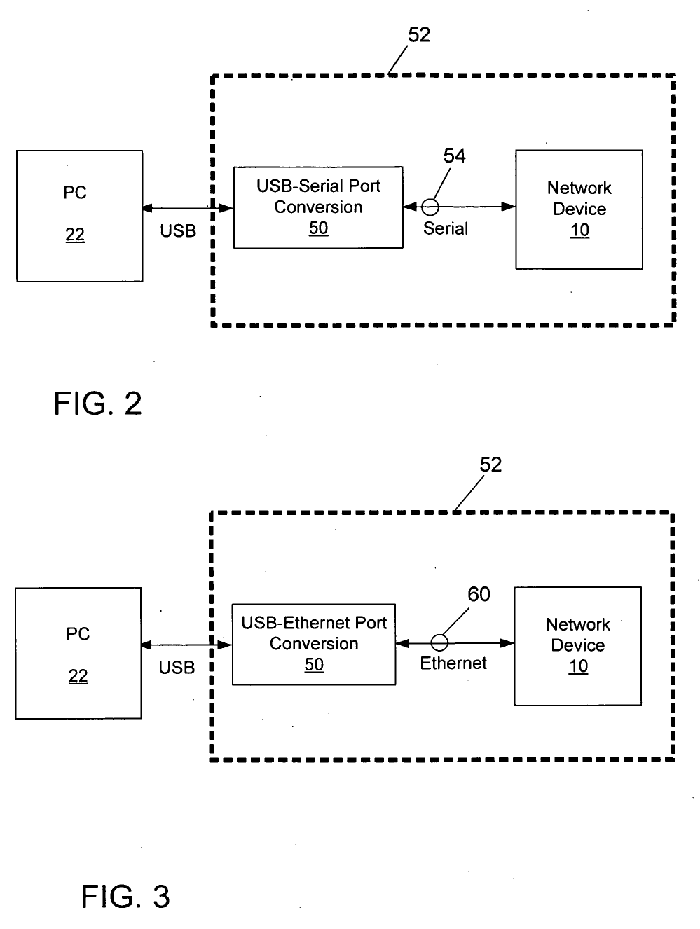

Another embodiment is depicted in FIG. 2. In this embodiment a USB/serial protocol conversion module 50 is integrated with the network device 10 in a single module 52. The USB/serial protocol conversion module 50 includes a slave USB port and a software driver that converts between USB messages and and the serial protocol data 54.

In this embodiment, the conversion module 50 includes an external USB slave port and internally the USB stack presents itself as a serial interface defined by the USB standard. The operating system must include a driver file for the module. The USB/serial port conversion module 50 sends all the characters received from program code executing on the network device to the PC over USB messages and similarly receives all USB messages from the PC and strips out the characters from the message that are to be relayed to the network device using the serial port protocol.

In this embodiment, users can manage the network device through the USB port using the same console management software previously utilized to manage the device through a serial port. Thus, a plug and play solution to maintaining backward compatibility with existing console management software is provided.

Still another embodiment is depicted in FIG. 3. In this embodiment a conversion module 50 is integrated with the network device 10 in a single module 52. An Ethernet interface of the conversion module 50 is depicted coupled providing Ethernet data 60 to the network device. This conversion module includes a slave USB port and software for converting between USB messages and Ethernet port converter.

In this embodiment, the PC sees the network device as an entity connected over an Ethernet interface. When the network device is connected to the PC over USB, the following events take place:
1. The PC sees an Ethernet adapter being activated over the USB.
2. The PC sees that the adapter link is up, and the IP stack initiates DHCP (Dynamic Host Configuration Protocol) requests.
3. The USB-Ethernet proxy module within the network device announces the presence of a device connected at the other end of the link.
4. A DHCP server module within the network device responds to DHCP requests from the PC over the USB interface and provides it an IP address.
5. The regular PC applications, such as web browser or telnet, can now communicate with the network device and manage it.

While older versions of common PC operating systems did not have support for this emulation feature, the feature is now more widely available with the newer operating systems. This embodiment provides complete management of the network device over the USB without requiring anything from the user and makes setting up of the device and the subsequent management very easy.

Accordingly, various embodiments of a cost effective, plug and play method for setting up and managing a network device have been described. These embodiments allow a user to connect to the slave USB port of a network device where the network device identifies its USB interface to the PC as one of the interfaces defined by the USB standard, i.e., either a mass storage device, an Ethernet device, or a serial port device. The PC treats this network device as one of the standard interfaces, and associated applications on the PC can now work over this interface. The user can then manage the device through the PC itself using day-to-day applications.

The invention may be implemented as program code, stored on a computer readable medium, that is executed by a digital computer. The computer readable medium may include, among other things, magnetic media, optical media, electromagnetic fields encoding digital information, and so on.

The invention has now been described with reference to the preferred embodiments. Alternatives and substitutions will now be apparent to persons of skill in the art. Accordingly, it is not intended to limit the invention except as provided by the appended claims.

What is claimed is:

1. A system for managing a network device, the system comprising:
a slave USB port module, including a slave USB port, integrated with the network device adapted to present a USB defined interface to a computer connected to the USB slave port;
a memory;
a processor, coupled to the USB slave port module and to the memory, configured to utilize the USB defined interface to communicate with a computer connected to the USB slave port to configure or manage the network device and to store management data in the memory.

2. The system of claim 1 where:
the defined interface presents at least a portion of the memory as a generic mass storage device to a computer coupled to the USB slave port; and
the memory stores a management file updated or stored by a connected computer which is accessed by the processor to update configuration or image files.

3. The system of claim 1 where:
the slave USB port module is adapted to convert USB messages received at the slave USB port from a connected computer to messages in an Ethernet format and to convert Ethernet messages from the network device into USB messages sent to a connected computer; and
the defined interface is adapted to present itself to a connected computer as an Ethernet interface so that networked management applications may be utilized on a connected computer to configure or manage the network device.

4. The system of claim 1 where:
the slave USB port module is adapted to convert USB messages received at the slave USB port from a connected computer to messages in a serial protocol format and to convert serial protocol messages from the network device into USB messages sent to a connected computer; and
the defined interface is adapted to present itself to a connected computer as a serial interface so that console management applications may be utilized on a connected computer to configure or manage the network device.

5. A system for managing a network device, the system comprising:
a USB slave port integrated with the network device having a USB defined interface;
a memory presented by the USB interface as generic mass storage device to a computer coupled to the USB slave port; and
a processor, coupled to the memory, configured to access a management file from the memory that has been modified or stored by a computer coupled to the USB slave port and to utilize information in the management file to configure or manage the network device.

6. A system for managing a network device, the system comprising:
a USB slave port module, including a USB slave port, with the module integrated with the network device, where the USB slave module is adapted to convert USB messages received from a computer connected to the slave USB port into messages in Ethernet format, to convert Ethernet messages from the network devices into USB messages sent to a connected computer, and where the module is adapted to present itself as an Ethernet interface to a computer connected to the slave USB port; and
where the network device is adapted to receive configuration or management information in Ethernet format from a connected computer connected to the USB slave port module and to utilize the information to update either configuration or management information stored in the memory.

7. A system for managing a network device, said system comprising:
a USB slave port module, including a USB slave port, with the module integrated with the network device, where the USB slave port module is adapted to convert USB messages received from a computer connected to the slave USB port into serial protocol format, to convert messages in a serial protocol format from the network device into USB messages sent to a connected computer, and where the module is adapted to present itself as a serial interface to computer connected to the slave USB port; and
where the network device is adapted to receive configuration or management information in serial protocol format from a computer connected to the USB slave port module and to utilize the information to update either configuration or management information stored in the memory.
